(19) United States
(12) Patent Application Publication
(10) Pub. No.: US 2005/0262019 A1
(43) Pub. Date: Nov. 24, 2005

(54) Methods, systems and computer program products for performing customer account updates

(76) Inventors: Jennifer Ebbert-Hughes, Roswell, GA (US); Barbara Olsen, Dunwoody, GA (US); Cynthia Searcy, Marietta, GA (US)

Correspondence Address: CANTOR COLBURN LLP, 55 GRIFFIN ROAD SOUTH, BLOOMFIELD, CT, 06002, US

(21) Appl. No.: 10/852,367

(22) Filed: May 24, 2004

(51) Int. Cl. G06F 17/60

(52) U.S. Cl. 705/40

(57) ABSTRACT

A method for performing customer account updates. The method includes receiving a customer account from a user and transmitting account update options to the user. An update transaction is received from the user, where the update transaction corresponds to the customer account and to two or more of the account update options. A service corresponding to the customer account is modified in response to the transaction including a request to modify the service. Point-to-point protocol (PPP) logins corresponding to the customer account are updated in response to the transaction including a request to update the PPP logins. Provisioning corresponding to the customer account is changed in response to the transaction including a request to change the provisioning. A request to update an ordering system is transmitted in response to at least one of the modifying, updating and changing.

### FIELD OF THE INVENTION

The present disclosure relates generally to computer networks and in particular, to methods, systems and computer program products for auditing network device configurations.

### BACKGROUND OF THE INVENTION

Computer systems that support customer accounts typically include a billing system, an ordering system, a customer data system and an operational support system. The billing system keeps track of customer accounts, charges that should be applied and the current balance associated with each customer. In telephone provider computer systems, the ordering system typically tracks requests for new service. The ordering system will interface with the operational support systems to provision customer telecommunication services and to assign telephone numbers to the customer. The ordering system also interfaces with the billing system to be sure that the billing is synchronized with what has been ordered by the customer. The customer data system maintains information about the customer such as name and billing address, activation date and account status.

These systems have often been developed and optimized for a specific purpose. For example, the billing software is optimized for billing and may not be efficient at interfacing with the ordering system. A customer account representative may be required to access several systems in order to make a relatively simple change such as updating a primary bill plan. In addition, these systems may be older and not able to easily handle some of the new types of service provided to telephone company customers. In many cases, the existing systems cannot process some of the more complex products such as digital subscriber line (DSL) accounts. DSL accounts often times involve layering several products with many different permutations.

### SUMMARY OF THE INVENTION

Embodiments of the present invention include a method for performing customer account updates. The method includes receiving a customer account from a user and transmitting account update options to the user. An update transaction is received from the user, where the update transaction corresponds to the customer account and to two or more of the account update options. A service corresponding to the customer account is modified in response to the transaction including a request to modify the service. Point-to-point protocol (PPP) logins corresponding to the customer account are updated in response to the transaction including a request to update the PPP logins. Provisioning corresponding to the customer account is changed in response to the transaction including a request to change the provisioning. A request to update an ordering system is transmitted in response to at least one of the modifying, updating and changing.

Further embodiments of the present invention include a system for performing customer account updates. The system includes an update tool in communication with an ordering system. The update tool includes instructions to implement a method including receiving a customer account from a user and transmitting account update options to the user. An update transaction is received from the user, where the update transaction corresponds to the customer account and to two or more of the account update options. A service corresponding to the customer account is modified in response to the transaction including a request to modify the service. Point-to-point protocol (PPP) logins corresponding to the customer account are updated in response to the transaction including a request to update the PPP logins. Provisioning corresponding to the customer account is changed in response to the transaction including a request to change the provisioning. A request to update an ordering system is transmitted in response to at least one of the modifying, updating and changing.

Still further embodiments of the present invention include a computer program product for performing customer account updates. The computer program product includes a storage medium readable by a processing circuit and stores instructions for execution by the processing circuit for facilitating a method that includes receiving a customer account from a user and transmitting account update options to the user. An update transaction is received from the user, where the update transaction corresponds to the customer account and to two or more of the account update options. A service corresponding to the customer account is modified in response to the transaction including a request to modify the service. Point-to-point protocol (PPP) logins corresponding to the customer account are updated in response to the transaction including a request to update the PPP logins. Provisioning corresponding to the customer account is changed in response to the transaction including a request to change the provisioning. A request to update an ordering system is transmitted in response to at least one of the modifying, updating and changing.

Other systems, methods and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring to the exemplary drawings wherein like elements are numbered alike in the several FIGURES:

FIG. 1 is a block diagram of a system for performing customer account updates in accordance with exemplary embodiments of the present invention;

FIG. 2 is a block diagram of an exemplary process for locating account information in accordance with exemplary embodiments of the present invention; and

FIG. 3 is a block diagram of an exemplary process for processing account requests in accordance with exemplary embodiments of the present invention.

### DETAILED DESCRIPTION OF THE INVENTION

Exemplary embodiments of the present invention include a customer account update tool that provides a consolidated front end to billing, ordering and operational support systems for handling customer account updates. These updates may include exception items that deviate from the standard customer account processing and may include billing corrections, changing service types and correcting point-to-point protocol (PPP) logins. The tool receives data from existing billing systems, ordering systems, customer data systems and operational support systems. In addition, the tool transmits update data to be written back to billing and ordering systems. The customer account update tool allows a customer account representative to perform non-standard customer account processing from a single interface and ensures that any updates made by the customer account representative are propagated to the existing billing and ordering systems.

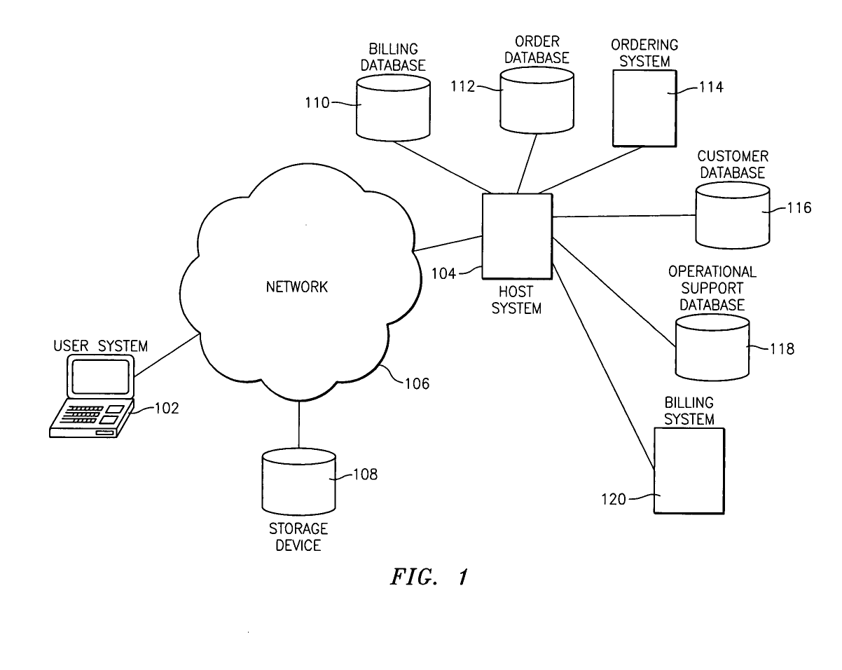

FIG. 1 is a block diagram of a system for performing customer account updates in accordance with exemplary embodiments of the present invention. FIG. 1 includes a host system 104 for executing the customer account update tool. The system in FIG. 1 also includes one or more user systems 102 through which users (e.g., customer account representatives) located at one or more geographic locations may contact the host system 104 to initiate customer account update functions. In exemplary embodiments of the present invention, the host system 104 executes the customer account update tool and the user system 102 is coupled to the host system 104 via a network 106. In alternate exemplary embodiments, the user system 102 is directly connected to the host system 104. Each user system 102 may be implemented using a general-purpose computer executing a computer program for carrying out the processes described herein. The user system 102 may be a personal computer (e.g., a lap top, a personal digital assistant) or a host attached terminal. If the user system 102 is a personal computer, the processing described herein may be shared by the user system 102 and the host system 104.

The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A user system 102 may be coupled to the host system through multiple networks (e.g., intranet and LAN) so that not all user systems 102 are coupled to the host system 104 through the same network. One or more of the user systems 102 and the host system 104 may be connected to the network 106 in a wireless fashion.

The storage device 108 depicted in FIG. 1 may be implemented using a variety of devices for storing electronic information. It is understood that the storage device 108 may be implemented using memory contained in the host system 104 or it may be a separate physical device. The storage device 108 is logically addressable as a consolidated data source across a distributed environment that includes a network 106. The physical data may be located in a variety of geographic locations depending on application and access requirements. Information stored in the storage device 108 may be retrieved and manipulated via the host system 104 and/or via the user system 102 if portions of the audit software are executed on the user system 102. The storage device 108 includes application data utilized by the customer account update tool. In exemplary embodiments of the present invention, the host system 104 operates as a database server and coordinates access to application data including data stored on the storage device 108. Access to data contained in the storage device 108 may be restricted based on user characteristics.

The host system 104 depicted in FIG. 1 may be implemented using one or more servers operating in response to a computer program stored in a storage medium accessible by the server. The host system 104 operates as a network server (e.g., a web server) to communicate with the user system 102. The host system 104 handles sending and receiving information to and from the user system 102 and can perform associated tasks. The host system 104 may reside behind a firewall to prevent unauthorized access to the host system 104 and enforce any limitations on authorized access. A firewall may be implemented using conventional hardware and/or software as is known in the art.

The host system 104 may also operate as an application server. The host system 104 executes one or more computer programs to implement the customer account update tool. The processing of the customer account update tool may be shared by the user system 102 and the host system 104 by providing an application (e.g., a java applet) to the user system 102. As previously described, it is understood that separate servers may be utilized to implement the network server functions and the application server functions. Alternatively, the network server, the firewall, and the application server may be implemented by a single server executing computer programs to perform the requisite functions.

The host system 104 depicted in FIG. 1 is in communication with a billing database 110 including data from a billing system 120, an order database 112 including data from an ordering system 114, a customer database 116 including customer data and an operational support database 118 including data from one or more operational support systems. Communication may be via a direct connection or via the same network 106 described previously or a separate network with the same attributes as the network 106 described previously. In exemplary embodiments of the present invention the customer account data relates to telephone service. In these exemplary embodiments, the billing database 110 includes customer billing data such as information about the primary and secondary bill plans, registration codes and any promotions associated with the customer account. The order database 112 includes customer order data such as type of service, order state and installation type. The customer database 116 includes data such as customer name, activation date, service identification, PPP login and account status. The operational support database 118 includes information relating to telephone number assignment and provisioning telecommunication service to the customer.

The billing database 110, order database 112, customer database 116 and operational support database 118 may be implemented using a variety of devices for storing electronic information. It is understood the billing database 110 may be implemented using memory contained in the billing system 120 or it may be contained in a separate physical device. Additionally, the order database 112 may be implemented using memory contained in the ordering system 114 or it may be contained in a separate physical device. Similarly, the customer database 116 and operational support database 118 may 110 may be implemented using memory contained in a customer system and operational support system, respectively, or they may be contained in separate physical devices. The physical data may be located in a variety of geographic locations depending on application and access requirements.

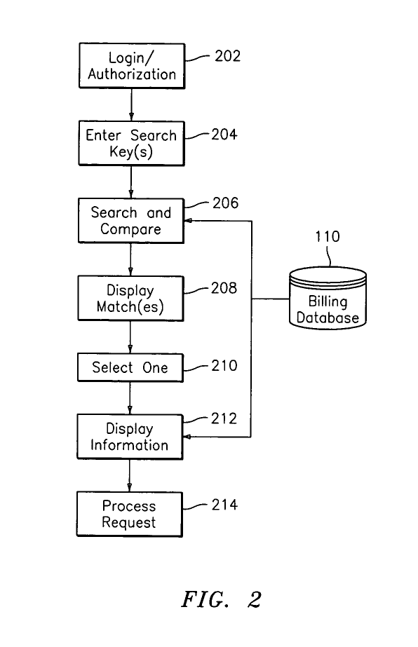

FIG. 2 is a block diagram of an exemplary process for locating account information in accordance with exemplary embodiments of the present invention. The process depicted in FIG. 2 may be utilized by a customer account representative to update a customer account. At 202, the user (e.g., customer account representative) initiates the customer account update tool and an authorization process is performed to check that the user is authorized. In exemplary embodiments of the present invention, the interactions with the user described in reference to FIG. 2 are performed via user interface screens displayed on the user system 102. Different users may have different levels of access to databases and functions within the customer account update tool based on their user identifications. At 204, the user enters value(s) for the search key(s). These values may include data such as billing telephone number (BTN), digital subscriber line (DSL) telephone number, PPP login, e-mail identification, e-mail alias and service identifier. At 206, the customer account update tool searches the billing database 110 for entries that match the search criteria entered in 204.

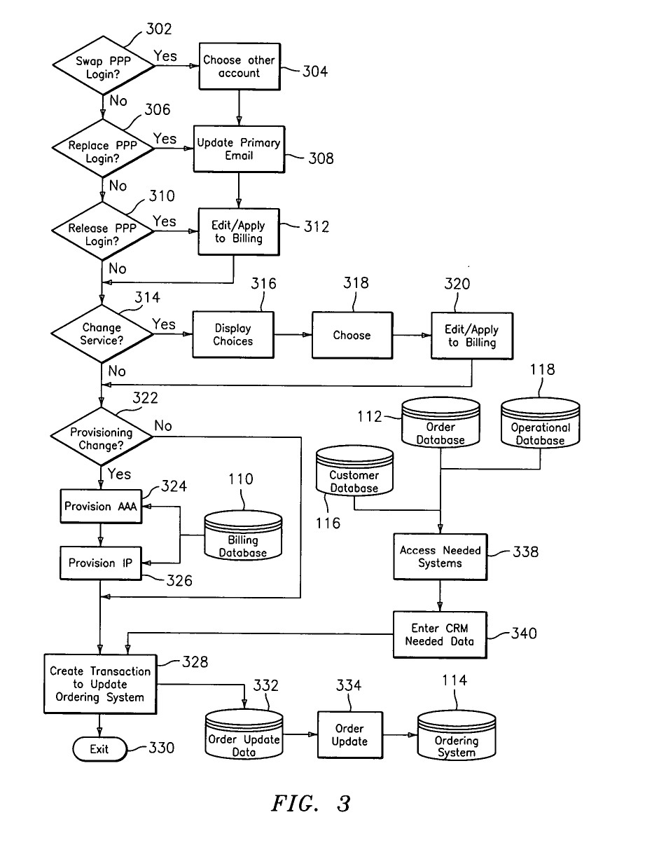

At 208, the matching entries are displayed to the user. In exemplary embodiments of the present invention, the information displayed for each matching entry includes the DSL telephone number, the BTN, the PPP login, the service identifier, the billing identifier, the customer name, the customer address, the billing status, and the status date. At 210, the user selects one of the matches and at 212, the customer account update tool displays additional account information relating to the entry. Additional account information may include customer information from the customer database 116, active billing information from the billing database 110 and/or current order information from the order database 112. In exemplary embodiments of the present invention, the customer information includes customer name, activation date, DSL start date, integrated fiber in the loop (IFITL)/DSL, DSL telephone number/BTN, service identifier, account status and PPP login. In addition, active billing information includes registration code, registration code description, primary bill plan, bill plan last update date, secondary bill plan(s) and promotions. Further, current order information includes order state, service, customer provided equipment (CPE) type, overlays and installation type. At 214, the customer account update tool processes the account request of the customer account representative. The processing of the account request is described in reference to FIG. 3.

FIG. 3 is a block diagram of an exemplary process for processing account requests in accordance with exemplary embodiments of the present invention. In exemplary embodiments of the present invention, the user selects from swap PPP login, replace PPP login, release PPP login, change service and re-provision and these options are presented to the user (e.g., via a user interface screen). The user may select one option, a subset of the options or all of the options from the user interface screen. PPP is a method of providing remote access communications. It may be utilized to connect a computer to the Internet and to establish a session between a customer's computer and the Internet service provider (ISP). If, at 302, it is determined the user has requested to swap the PPP login, then 304 is performed and the PPP login of the currently selected account (the account selected in 210) will be changed. The service identifier corresponding to the PPP remains the same, but it is associated with a different, available, valid PPP login. The removed PPP login will be made available for another assignment. The customer account tool provides the user with a function to search for the other account and provides information so that the user can confirm the selection of the pair. In exemplary embodiments of the present invention, the minimum information on each account includes customer name, authentication phrase, account status and customer address. The PPP logins will be re-assigned without allowing them to be made available to other accounts. The customer account update tool will provide notification to the user of any conflicts causing accounts to be ineligible for the swap. The swap and provisioning will fail and give an error message/report if the user has attempted to perform a PPP swap on an account that has a static IP address. If the PPP login is already taken by other users, if there is an invalid number of characters in PPP entered for the swap, and/or if there is an invalid character selection in PPP entered for the swap, the system will prompt the user to correct and resubmit without delaying the transaction. Processing then continues from 304 to 308 where the primary e-mail is updated because changing the PPP login necessitates a change to the primary e-mail address. At 312, the update to the PPP login is applied to the billing database 110.

If it is determined, at 302, that the user did not select swap PPP login, then processing continues at 306. If at 306 it is determined that the user selected replace PPP login, then the current PPP login is replaced with a value entered by the user and processing continues at 308 as described previously. Otherwise, processing continues at 310. If it is determined at 310 that the user has selected release PPP login, then 312 is performed as described previously to make the released PPP login available for another assignment. Part of the process of releasing the PPP login includes validating the status of the login and requesting that the user confirm the release action. After 312 has been completed, processing continues to 314.

Referring to FIG. 3, if it is determined, at 314, that a change in service has been requested by, e.g., the customer account manager, then 316 is performed to display options associated with changing the service. In exemplary embodiments of the present invention, the options include: change registration code, change primary bill plan and/or associated promotions, change secondary bill plan and/or associated promotions. The user is presented with the current values of these items. At 318, the user selects one or more of these options and the change is processed. If the user selects change registration code at 318, then the customer account update tool provides a user interface for the registration code to be changed. In exemplary embodiments of the present invention, the user interface may include providing a data entry screen to allow the user to enter the new registration code, providing a user selection screen for the user to select the new registration code from a list of codes that include registration code descriptions, and/or allowing the user to proceed with the existing registration code. Once the new registration code has been selected or the old registration code kept, the system displays the following types of information: new registration code, registration code description, sales channel and consumer/business customer.

If the user selects change primary bill plan at 318, then the customer account update tool displays, on a user interface, the primary bill plans available for selection. Information about each bill plan includes information such as primary bill plan, primary bill plan name, bill plan description. If a new primary bill plan is selected, it is displayed to the user via a user interface screen. If the user selects change secondary bill plan at 318, then the customer account update tool displays, the secondary bill plans available for selection. Information about each bill plan includes information such as secondary bill plan, secondary bill plan name, bill plan description. If a new secondary bill plan is selected, it is displayed to the user via a user interface screen.

If the user selects change primary bill plan promotions at 318, then the customer account update tool displays, via a user interface, a description of the promotions available for the selected primary bill plan. The customer account update tool provides a way for the user to select a new promotion(s) and remove old one(s). The user may select no promotion, one promotion, some promotions or all promotions. Once the user selects a new promotion(s) associated with the primary bill plan, the new promotion is displayed on the user interface screen. If the user selects change secondary bill plan promotions at 318, then the customer account update tool displays, via a user interface, a description of the promotions available for the selected secondary bill plan. The customer account update tool provides a way for the user to select a new promotion(s) and remove old one(s). The user may select no promotion, one promotion, some promotions or all promotions. Once the user selects a new promotion(s) associated with the secondary bill plan, the new promotion is displayed on the user interface screen. Exemplary embodiments of the present invention provide the ability to apply a promotion in full, remainder or increments depending on the customer requirement as determined by the customer account representatives.

At 320, the change in service and associated billing information changes are displayed and the user is requested to confirm the changes. The user interface screen containing the billing information changes includes login identification, date/time of change, old registration code, new registration code, old primary bill plan, new primary bill plan, old secondary bill plan(s), new secondary bill plan(s), old primary promotions, old secondary promotions, new primary promotions and new secondary promotions. The actual data displayed will vary depending on the type of change made by the user and implementation requirements. In exemplary embodiments of the present invention, the user may enter notes about the billing correction activity. In addition, logging of the data displayed, along with the user id of the customer account representative making the change may be performed. Processing then continues at 322.

At 322 in FIG. 3, a determination is made about whether a provisioning change is required based on the changes made by the user in the previous steps or whether the user has requested a provisioning change. If a provisioning change is not required, then processing continues at 328. If a provisioning change is required then 324 and 326 are performed to determine what provisioning changes need to be applied and then to initiate the provisioning. Provision AA at 324 and provision IP at 326 include initiating the updating of the systems/servers with the provisioning information to allow customers to access the network. Provisioning actually sets up the desired service (Internet, WAN, LAN, etc.) via the network and servers, and allows logon access to the network. In exemplary embodiments of the present invention this is performed by displaying the provisioning data and the billing data to compare the provisioning needs. The customer account update tool then initiates the provisioning changes and any additional data needed to synchronize the provisioning data and the billing data. At 328, the customer account update tool creates a transaction to update the ordering system with any changes that have been made in 302 through 326. The provisioning information is automatically passed and the information is updated to the ordering system 114. It has already been updated to provisioning and billing. In order to create the updated transaction at 328, the customer database 116, the order database 112 and the operational database 118 may be accessed at 338 and 340. The resulting transaction is stored at 332 and the customer account tool initiates updating the order at 334 via access to the ordering system 114. The user portion of the processing ends at 330.

Exemplary embodiments of the present invention include the ability to create reports based on the data manipulated by the customer account update tool. A report on any transaction created at 328 in FIG. 3 may be created to track the updates made via the customer account update tool. The examples given in FIG. 3 of exception processing in the telecommunications industry is meant to be exemplary in nature. Other exception processing both within the telecommunications industry and in other industries is possible by utilizing exemplary embodiments of the present invention.

Exemplary embodiments of the present invention allow a customer account representative to perform non-standard customer account processing from a single interface. In addition, exemplary embodiments of the present invention propagate any changes made by the customer account representative to existing billing and ordering systems.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for performing customer account updates, the method comprising:
receiving a customer account from a user;
transmitting account update options to the user;
receiving an update transaction from the user, the update transaction corresponding to the customer account and to two or more of the account update options;
modifying a service corresponding to the customer account in response to the transaction including a request to modify the service;
updating point-to-point protocol (PPP) logins corresponding to the customer account in response to the transaction including a request to update the PPP logins;
changing the provisioning corresponding to the customer account in response to the transaction including a request to change the provisioning; and
transmitting a request to update an ordering system in response to at least one of the modifying, updating and changing.

2. The method of claim 1 further comprising transmitting a request to update billing data in response to at least one of the modifying and the changing.

3. The method of claim 1 further comprising receiving search keys from the user, wherein the customer account is responsive to the search keys.

4. The method of claim 1 further comprising writing the data associated with the request to update an ordering system to a system log.

5. The method of claim 1 further comprising generating a report, the report including data associated with the request to update an ordering system.

6. The method of claim 1 wherein input to creating the request to update an ordering system includes order data, customer data and operational data.

7. The method of claim 1 wherein input to changing the provisioning includes billing data.

8. The method of claim 1 wherein the request to modify the service includes at least one of a change to a registration code, a change to the primary bill plan, a change to the secondary bill plan and a change to the promotions.

9. The method of claim 1 wherein the request to update the PPP logins includes swapping two of the PPP logins.

10. The method of claim 9 wherein the updating includes updating a primary e-mail and applying the updating to billing data.

11. The method of claim 1 wherein the request to update the PPP logins includes replacing one of the PPP logins.

12. The method of claim 11 wherein the updating includes applying the updating to billing data.

13. The method of claim 1 wherein the request to update the PPP logins includes releasing one of the PPP logins for reuse.

14. A system for performing customer account updates, the system comprising:
an update tool in communication with an ordering system, wherein the update tool includes instructions to implement a method comprising:
receiving a customer account from a user;
transmitting account update options to the user;
receiving an update transaction from the user, the update transaction corresponding to the customer account and to two or more of the account update options;
modifying a service corresponding to the customer account in response to the transaction including a request to modify the service;
updating point-to-point protocol (PPP) logins corresponding to the customer account in response to the transaction including a request to update the PPP logins;
changing the provisioning corresponding to the customer account in response to the transaction including a request to change the provisioning; and
transmitting a request to update an ordering system in response to at least one of the modifying, updating and changing.

15. The system of claim 14 wherein the update tool is in communication with the ordering system via a network.

16. The system of claim 15 wherein the network includes one or more of an Internet and an intranet.

17. The system of claim 14 wherein the method implemented by the update tool further comprises transmitting a request to update billing data in response to at least one of the modifying and the changing.

18. The system of claim 14 wherein the method implemented by the update tool further comprises receiving search keys from the user and the customer account is responsive to the search keys.

19. The system of claim 14 wherein the method implemented by the update tool further comprises writing the data associated with the request to update an ordering system to a log.

20. The system of claim 14 wherein the method implemented by the update tool further comprises generating a report including data associated with the request to update an ordering system.

21. A computer program product for performing customer account updates, the computer program product comprising:
a storage medium readable by a processing circuit and storing instructions for execution by the processing circuit for facilitating a method comprising:
receiving a customer account from a user;
transmitting account update options to the user;
receiving an update transaction from the user, the update transaction corresponding to the customer account and to two or more of the account update options;
modifying a service corresponding to the customer account in response to the transaction including a request to modify the service;
updating point-to-point protocol (PPP) logins corresponding to the customer account in response to the transaction including a request to update the PPP logins;
changing the provisioning corresponding to the customer account in response to the transaction including a request to change the provisioning; and
transmitting a request to update an ordering system in response to at least one of the modifying, updating and changing.

22. The computer program product of claim 21, wherein the method further comprises transmitting a request to update billing data in response to at least one of the modifying and the changing.

23. The computer program product of claim 21, wherein the method further comprises receiving search keys from the user and the customer account is responsive to the search keys.

24. The computer program product of claim 21, wherein the method further comprises writing the data associated with the request to update an ordering system to a log.

25. The computer program product of claim 21, wherein the method further comprises generating a report including data associated with the request to update an ordering system.
